(19) United States
(12) Patent Application Publication
(10) Pub. No.: US 2019/0353217 A1
(43) Pub. Date: Nov. 21, 2019

(54) FRICTION MATERIAL

(71) Applicant: ROCKWOOL International A/S, Hedehusene (DK)

(72) Inventors: Arnoldus Maria KERSSEMAKERS, Montfort (NL); Fernao Joseph Cornelis PERSOON, Echt (NL)

(21) Appl. No.: 16/299,363

(22) Filed: Mar. 12, 2019

(30) Foreign Application Priority Data
May 18, 2018 (EP) 18173336.1

(51) Int. Cl. F16D 69/02; F16D 65/092

(52) U.S. Cl. CPC F16D 69/026; F16D 65/092; F16D 2200/0069; F16D 2200/0043; F16D 2200/0065; F16D 2200/0056

(57) ABSTRACT

The invention provides use of fibre clusters in a friction material, friction materials comprising fibre clusters, and methods of making friction materials comprising fibre clusters. The fibre clusters have properties as defined in the specification.

### FIELD OF INVENTION

The invention relates to a friction material exhibiting reduced wear in use and to processes for preparation of such a friction material. The invention also relates to man-made vitreous fibre (MMVF) clusters suitable for use in preparation of these friction materials and for reduction of wear of the friction materials.

### BACKGROUND

Friction materials are widely used in a variety of applications such as in brake or clutch devices. They are often used for instance in the form of brake pads, brake shoes, brake linings, friction plates and clutch facings. They may be used in a variety of applications including industrial machines and transport machines or vehicles such as elevators, passenger vehicles and the like.

One important characteristic of a friction material is that it should exhibit low wear in use. Wearing of the friction material can lead to an increase in emissions, which is undesirable. The present invention aims to produce friction materials which exhibit reduced wear.

WO2011/042533 describes the use of inorganic fibre balls in a friction material for the purpose of reducing NVH (noise and vibration harshness). This document teaches to use normal lubricants and abrasives as fillers to adjust the wear properties of the friction material. There is also no requirement for the inorganic fibre balls to have any particular size distribution.

WO2017/212029 and technical paper “White stone fibres for reduced wear in friction applications”, Persoon et al., EB2016-MDS-003, presented and published at the EuroBrake 2016, Milan, Italy, both describe one solution for reducing wear in friction materials. This involves using a different from normal fibre chemistry for man-made vitreous fibres (MMVF) that are incorporated into the friction material as reinforcing fibres. The fibres are incorporated as “loose” fibres and are of lower abrasiveness than other MMVF commonly used in friction materials such as brake pads, thereby reducing the wear.

It is well known to use MMVF as components of formulations for friction materials. The present invention is based on the finding that inclusion of MMVF in the form of discrete clusters in the friction material formulation can lead to reduced wear, in comparison with including MMVF in the form of loose fibres.

### SUMMARY

According to a first aspect of the invention we provide the use of MMVF clusters in a friction material formulation for the reduction of wear of said friction material in use.

Thus, a friction material containing MMVF in the form of clusters will exhibit reduced wear in use in comparison with a friction material having the same formulation but containing the same percentage of the same MMVF in loose form. Wear can be determined according to standard tests such as the wear elements of SAE J2521: 2003-06, SAE J 2522: 2006-01, and SAE J 2707: 2005-02.

Fibres of the MMVF type when incorporated into friction materials are conventionally included as loose fibres, namely single individual fibres which are not substantially entangled with each other. When included in a matrix, such loose fibres are sometimes referred to as dispersed fibres, because they are dispersed throughout the matrix. In contrast, the fibre clusters used according to the present invention are balls of agglomerated MMVF, which may be to some extent interwoven or entangled. They may therefore have the form of granules. Preferably they are regular in shape, for instance ovoid or spheroid (substantially spherical). When incorporated into a friction material, they may have a discoid shape.

We have found that the size distribution of the MMVF clusters is important in optimising wear reduction. To be defined as a cluster, a collection of fibres should have a minimum dimension of at least 0.4 mm. We find that the best wear reduction performance is given by MMVF clusters of sizes in the range 0.6 to 1.6 mm, preferably 0.6 to 1.0 mm. Accordingly, preferably the MMVF clusters used in the invention are of size distribution in which at least 95 wt % of the MMVF clusters have size in the range 0.6 to 1.6 mm. Preferably at least 97 wt %, more preferably at least 98 wt %, and even more preferably substantially 100 wt % of the MMVF clusters have size in this range. Size can be determined by sieving. Provision of the defined size distribution can also be done by use of sieving.

Thus according to a second aspect of the invention we provide a method for the preparation of a friction material comprising the step of incorporating MMVF clusters into a friction material formulation, wherein the MMVF clusters have a size distribution such that at least 95 wt % have size in the range 0.6 to 1.6 mm.

According to a third aspect of the invention there is provided the use of MMVF clusters in the preparation of a friction material formulation, wherein the MMVF clusters have a size distribution such that at least 95 wt % have size in the range 0.6 to 1.6 mm.

According to a fourth aspect of the invention there is provided a mixture of man-made vitreous fibres comprising from 1 to 100% by weight MMVF in the form of clusters, wherein at least 95 wt % of said clusters have size in the range 0.6 to 1.6 mm.

The mixture may comprise at least 50 wt %, preferably at least 75 wt % and even 100 wt % MMVF in the form of clusters. The remainder is formed of MMVF in the form of loose fibres.

According to a fifth aspect of the invention we provide a friction material obtainable by the method of the second aspect of the invention.

### DETAILED DESCRIPTION

In the method of the invention, at least 95 wt % of the MMVF clusters have a size in the range from 0.6 mm to 1.6 mm, preferably from 0.6 mm to 1.0 mm. Preferably all of the MMVF clusters used in the method have a size in that range. Size can be controlled using conventional sieving techniques. The size refers to the largest dimension of the man-made vitreous fibre clusters, which need not have a regular spherical shape.

The inventors have found that, surprisingly, using MMVF clusters within this narrow size range brings benefits for wear reduction when the friction material is in use. In particular, the wear of the friction material itself is reduced. This is of current concern in the automotive industry, in which it is desirable to reduce the wear of brake pads to reduce particulate emissions to the environment. Using MMVF clusters within this narrow size range may contribute to wear rate reduction due to the size of the reservoir provided by the MMVF clusters, in which wear debris may accumulate rather than being lost to the environment.

In the friction material made according to the invention preferably the level of MMVF clusters is less than 15 wt %, such as less than 12 wt %. It is possible to include loose fibres as well as MMVF clusters. In this case, it is preferred that the loose fibres are also MMVF, more preferably of the same type and composition as the MMVF that are used to form the clusters. In this case, it is also preferred that the total level of MMVF clusters and loose fibres is less than 15 wt %, preferably less than 12 wt %. Preferably the level of MMVF clusters in the friction material is at least 1 wt %, preferably at least 3 wt %, more preferably at least 5 wt %.

Using a mixture of MMVF loose fibres and MMVF clusters is beneficial for achieving the wear reduction properties associated with the clusters alongside the strengthening properties associated with the loose fibres.

When both MMVF clusters and loose MMVF are used, preferably at least 50 wt %, more preferably at least 75 wt %, of the blend is made up of MMVF clusters, with the balance being loose MMVF.

The friction material may comprise other types of loose fibres, such as aramid fibres, steel fibres, carbon fibres, and other types of mineral fibres. For example, other fibre types may be used as reinforcing fibres. A mixture of different types of reinforcing fibres with complementing properties are used. Examples for reinforcing fibres other than MMVF are glass fibres, mineral fibres, metallic fibres, carbon fibres, aramid fibres, potassium titanate fibres, sepiolite fibres and ceramic fibres. Metallic components for reinforcement may also have a shape other than a fibre shape. As is usual in the art, in the present application all metallic components included in the friction material are considered as metallic reinforcing fibres whatever the shape thereof is (fibre, chips, wool, etc.). Examples of metallic fibres include steel, brass and copper. Since steel fibres often suffer from the drawback of rusting, zinc metal is often distributed over the friction material when steel fibres are used. Metallic fibres may be oxidized or phosphatized. An example of aramid fibres are Kevlar fibres. Ceramic fibres are typically made of metal oxides such as alumina or carbides such as silicon carbide.

Preferably all of the loose fibres are loose MMVF.

The MMVF used to form the clusters preferably have length in the range of 100 to 650 μm, preferably 100 to 350 μm.

Fibre clusters made from medium length fibres (250-350 μm) can result in a particularly stable coefficient of friction. Using fibre clusters made from short or medium length fibres (100-350 μm) can result in wear reduction compared to using loose fibres.

Fibre diameter is also typically in the range 3 to 10 microns.

The fibre diameter and fibre length of the plurality of man-made vitreous fibres that make up each MMVF cluster are both number averages. The aspect ratio is calculated as the number average length divided by the number average diameter. The number average fibre length is preferably no greater than 200 μm. The number average fibre diameter is preferably no less than 4.5 μm. The aspect ratio is preferably no greater than 60, more preferably no greater than 40, more preferably no greater than 30.

Generally the MMVF clusters are blended with the remainder of the friction material formulation in such a way as to remain as discrete and coherent clusters of MMVF in the final friction material. As is conventional, the friction material formulation is generally formed into the desired final form by moulding and compression. Preferably the MMVF clusters, and optionally any loose MMVF, are incorporated into the mixture of components at the final mixing step prior to pressing and curing, to preserve the shape of the MMVF clusters. Alternatively, the MMVF clusters may be coated with a suitable bonding agent prior to mixing, such that the clusters' shape is preserved even when combining into the mixture at the same time as the other components of the friction material.

We find that in a product made according to the process of the invention the clusters remain as discrete and coherent clusters but rather than being of ovoid or substantially spherical form are in discoid form. Namely their diameter is often at least 3 times, sometimes at least 4 times the height. Height is defined as the direction within the friction material along which compression has been exerted.

MMVF used for the fibre clusters in this invention may have a composition including for instance 35-45 wt % SiO₂, 16-23 wt % Al₂O₃, 0.3-0.7 wt % TiO₂, <1.5 wt % Fe₂O₃, 20 to 30 wt % CaO, in particular 25-27 wt % CaO, 1 to 5 wt % MgO, in particular 3-7 wt % MgO, <2.0 wt % Na₂O, <0.6 wt % K₂O, <0.3 wt % P₂O₅, <0.2 wt % MnO. Chemical properties can be ascertained using XRF.

Suitable types of MMVF for the MMVF clusters include stone fibres, glass fibres, slag fibres and ceramic fibres. Preferably stone fibres are used.

Preferably the composition of the fibres making up the man-made vitreous fibre clusters comprises less than 50 wt % SiO₂ and greater than 15 wt % Al₂O₃. This may help to make the MMVF bio-soluble.

Preferably the man-made vitreous fibre clusters comprise no more than 2 wt %, preferably no more than 1 wt %, of shot of size >63 μm.

Fibres may be provided with known coatings.

The fibre clusters for use in the method of the invention preferably have a moisture content of less than 0.05 wt %.

In a preferred process for the preparation of MMVF clusters, MMVF (man-made vitreous fibres) are mixed in a mixer. By this mixing process loose MMVF are agitated or rolled against each other so that agglomeration occurs to form the MMVF clusters. The mixer preferably provides a circular motion.

It is more preferred to mix the MMVF with a liquid in a mixer and drying the obtained mixture to obtain MMVF clusters. The presence of the liquid enhances the firmness of the clusters obtained. The liquid used should be vaporizable. A low viscosity liquid is preferable. Examples for suitable liquids are water and organic solvents, e g alcohols, water based emulsions and mixtures thereof.

Preferred liquids are water and water based emulsions. The liquid and the MMVF may be simply fed into the mixer. It is also possible to spray the liquid on the MMVF which may cause a better preliminary distribution of the liquid on the fibres. It is further preferred that the liquid employed contains a binder since the binder further improves the firmness of the MMVF clusters obtained.

The MMVF used for preparing the MMVF clusters are preferably relatively short fibres, such as a length of 100 to 500 μm, preferably 100 to 350 μm otherwise the liquid cannot be distributed well on the fibre surface. Appropriately, the MMVF are in the form of loose MMVF or predominately in the form of loose MMVF. In the preferred mixing step, the MMVF are mixed with the liquid, preferably containing a binder, so that the liquid is distributed on the surface of the fibres. In addition, the MMVF are moved, preferably by a circular motion, so that the MMVF agglomerate or ball up, respectively, to form the MMVF clusters. Hence, the mixing step preferably comprises mixing the MMVF with the liquid, preferably containing the binder, and rolling the MMVF on which the liquid is distributed to form the MMVF clusters. The liquid supports the formation of the clusters.

In general, the mixing step may optionally comprise two stages: a first more vigorous mixing to achieve mixing of the liquid with the MMVF, and a second, more gentle, mixing or rolling in order to ball up the MMVF on which the liquid is distributed.

The mixer employed in the mixing step may be any common mixing device generally known in the art, for instance a horizontal mixer or a vertical mixer. It may be useful that the mixer includes choppers, e.g. a vertical or horizontal mixer having choppers. Appropriately, the mixing time may be in the range of 1 to 20 minutes and preferably in the range of 2 to 8 minutes. Appropriately the head axle speed is in the range of 50-300 rpm. The mixing process preferably consists of a first stage with choppers rotation, e g., at 2500-3500 rpm or approximately at 3000 rpm, to distribute the liquid and a second stage without chopped activity for maximum ball formation. The mixing parameters however may vary depending on the type of MMVF, the mixer, the ball size desired, etc.

If a liquid is used for the preparation, the product obtained containing MMVF clusters needs to be dried when discharged from the mixer because products with a too high liquid content cannot be tolerated in friction materials. In the drying step, the liquid is evaporated from the MMVF clusters for which commonly known methods can be used, e g drying in an oven (static drying), drying in a dispersion dryer or drying in a fluid bed dryer. The drying step may result in a complete removal of the liquid, though a small amount of liquid remaining in the MVMF clusters may be acceptable. When water is used as the liquid, the formed MMVF clusters are not very strong after drying so that the clusters may be opened too easily when they are mixed into a friction material formulation if the mechanical load is too high.

MMVF clusters having a remarkably improved strength can be obtained when the inorganic fibres are mixed with a liquid containing a binder which is a preferred embodiment according to the invention. The MMVF clusters thus obtained are very “strong” after drying and are hardly opened when mixed into the friction material formulation. It is believed that the improved strength of the MMVF clusters is caused by the binder on the fibre surface sticking together the fibres after drying.

As a binder, it is possible to use organic and inorganic binders which are known to the person skilled in the art. A single binder or a mixture of two or more binders may be used. Examples of suitable binders are acrylic resins such as acrylates or methacrylates, alkyd resins, saturated and unsaturated polyester resins, polyurethanes based on di- or polyisocyanates and di- or polyols, epoxy resins, silicone resins, urea resins, melamine resins, phenolic resins, waterglass, alkyl silicate binders, cellulose esters, such as esters of cellulose with acetic acid or butyric acid, polyvinyl resins such as polyolefins, polyvinylchloride, polyvinylidene chloride, polyvinyl alcohol, polyvinyl acetate, polyvinyl ether, polyvinyl ester, polyvinyl pyrrolidone and polystyrene resins and derivatives and copolymers of these polyvinyl resins, nitrocellulose, chlorinated rubbers, glucose and oil varnishes

More specific examples of the binder include poly vinylacetate resin, vinylchloride-vinylacetate copolymer, polyacrylonitrile resin, polycarbonate resin, polyamide resin, butyral resin, polyurethane (PU) resins, vinylidenechloride-vinylchloride copolymer, styrene-butadiene copolymer, vinylidenechloride-acrylonitrile copolymer, vinylchloride-vinylacetate-maleic anhydride copolymer, silicone-alkyd resin, phenol-formaldehyde resin, styrene-alkyd resin, benzoguanamine resin, epoxyacrylate resin, urethaneacrylate resin, poly-N-vinylcarbazole resin, polyvinylbutyral resin, polyvinylformal resin, polysulfone resin, casein, gelatin, ethylcellulose, carboxymethyl cellulose, vinylidenechloride-based polymer latex, acrylonitrile-butadiene copolymer, styrene butadiene rubber (SBR), vinyltoluene-styrene copolymer, soybean oil-modified alkyd resin, nitrated polystyrene resin, polymethylstyrene resin, polyisoprene resin, polyarylate resin, polyhaloarylate resin, polyaryl ether resin, polyvinylacrylate resin, and polyesteracrylate resin. Suitable binders are e g SBR and PU based binders. The liquid containing a binder may be an aqueous or non-aqueous solution or dispersion and is preferably a latex, latex emulsion or polymer dispersion. The liquid is preferably water or an aqueous liquid. The liquid containing a binder is preferably a water based emulsion.

The content of binder in the liquid may vary. Generally, the binder content in the liquid is suitably in the range of 10 to 90% by weight, preferably 30 to 60% by weight. The ratio of liquid to MMVF to be mixed may vary, but an appropriate ratio by weight of liquid to MMVF may be in the range of 1 to 30%, a range of 5 to 15% being preferred, wherein the liquid refers to the liquid employed, i.e. optionally including the binder and/or other additives.

Apart from the binder, the liquid may also contain other additives, but generally it is not advantageous to add such further additives. In particular, the MMVF clusters according to the invention generally do not include MMVF having wetting agents or surfactants on the fibre surface. This is because wetting agents and surfactants generally weaken the strength of the MMVF clusters resulting in an opening of the clusters and a homogeneous distribution of the fibres in the friction material formulation. Accordingly, it is generally preferred that the liquid used for preparing MMVF clusters does not include wetting agents or surfactants.

With the process of preparing MMVF clusters described above, wherein preferably MMVF are mixed with the binder-containing liquid and subsequently dried, it is possible to prepare MMVF mixtures which include more than 80% by weight and up to 100% by weight, preferably more than 90% by weight of MMVF clusters and up to 100% by weight, based on the total weight of the MMVF mixture. That is, the MMVF mixture obtained includes 20% by weight or less and preferably 10% by weight or less of loose MMVF. In addition, it is preferable that the MMVF mixture obtained is essentially free of shots which means that shots of >125 μm are included in the inorganic fibre mixture in an amount of from 0 to at most 0 2% by weight. The described process of the invention even allows the preparation of MMVF mixtures containing approximately 100% by weight of MMVF clusters. With the process described, MMVF clusters having a small average size (<2 mm) can be prepared.

The MMVF mixture containing MMVF clusters as described above may be used as is for the incorporation into the friction material formulation as discussed below. Since loose MMVF may also have a beneficial effect on friction materials with respect to reinforcement, it is also possible to mix the MMVF mixture mainly comprising MVMF clusters as described above with a common MMVF mixture mainly comprising loose MMVF in order to obtain a MMVF mixture with an adjusted content of MMVF clusters in accordance with the user's need. Thus, MMVF mixtures can be prepared and used for incorporation into the friction material formulation. Alternatively, it is of course also possible to incorporate MMVF mixtures containing MMVF clusters according to the process of the invention and normal loose MMVF mixtures into the friction material formulation separately.

MMVF suitable for use in making MMVF clusters and/or for incorporating into the friction material as loose fibres may be made by any suitable method, for example by feeding a glass melt, rock melt or slag melt to a cascade spinner or a spinning cup and collecting the fibres thus formed. Shots may be removed by conventional sieving techniques.

The friction material formulation refers to a mixture of the components used for preparing the friction material. By incorporating the inorganic fibres, preferably mineral fibres, or MMVF clusters, respectively, into the friction material, the inorganic fibres or MMVF clusters, respectively, are added to or mixed with the components. The order of mixing the components of the friction material formulation and the inorganic fibres or MMVF clusters, respectively, is not restricted. That is, the MMVF clusters may be e.g., added to the binding agent of the friction material and mixed, and at the same time or subsequently other components of the friction material formulation such as reinforcing fibres, fillers or frictional additives may be added. Any other order is also possible. It may however be advantageous to add the MMVF clusters to a pre-mix of all or most of the other components of the friction material composition in order to minimize the mechanical load applied to the inorganic fibre balls.

Preferably, all of the starting materials for the friction material other than the MMVF clusters are combined prior to adding the MMVF clusters, so as to preserve as much as possible the three-dimensional shape of the MMVF clusters. Alternatively, the MMVF clusters may be incorporated into the mixture at the same step as the other starting materials for the friction material. In this case, the MMVF clusters may be provided with a coating such as a binding agent to help to preserve the 3-dimensional shape of the MMVF clusters.

In a preferred embodiment, 5% by weight to 100% by weight, preferably from 10% by weight to 100% by weight, of the total amount of mineral fibres added in the friction material formulation are MVMF clusters, the remainder being loose mineral fibres. In addition, the friction material may contain other inorganic fibres. In another embodiment it may be suitable that 5% by weight to 100% by weight, preferably from 10% by weight to 100% by weight, of the total amount of inorganic fibres added in the friction material formulation are MMVF clusters, the remainder being loose inorganic fibres.

In the method of the invention, the amount of MMVF clusters incorporated into the mixture prior to pressing and curing is preferably from 1 to 10 v/v % of the starting materials.

The friction material refers to the product obtained after forming and hardening the friction material formulation in which the MMVF clusters have been incorporated and includes also those products wherein the friction materials was subjected to an after-treatment such as scorching, cutting, polishing, gluing on substrates. The hardening may be a simple hardening or solidification, e.g. by solvent removal from the formulation or cooling. Preferably the friction material formulation is hardened by curing the friction material formulation or the binding agent, respectively.

The friction material may comprise one or more binding agents. After hardening, preferably during curing, the binding agents maintain the structural integrity under mechanical and thermal stress. The binding agent forms the matrix in which the other components are embedded.

The binding agent may be organic or inorganic but usually and preferably an organic binding agent is used. Thermosetting and thermoplastic binding agents may be employed, thermosetting binding agents being preferred. Examples of suitable binding agents for the friction material formulation are phenolic resins including phenol-formaldehyde resins, e.g. novolac resins, so-called COPNA resins (condense polynuclear aromatic resins), silicone-modified resins also referred to as phenolic siloxane resins which are reaction products of silicone oil or silicone rubber and phenolic resins, cyanate ester resins, epoxy-modified resins, such as epoxy-modified phenolic resins, epoxy resins in combination with specific curing agents such as anhydrides, polyimide resins, e.g. a product of a fluoro resin and calcium carbonate. Preferred binding agents are phenolic based resins, in particular phenol-formaldehyde tougheners such as epoxy resin or filled with wood flour. COPNA resins are often used in combination with graphite.

In addition, the friction material formulation may comprise one or more types of reinforcing fibres. Typically a mixture of different types of reinforcing fibres with complementing properties are used. Examples for reinforcing fibres are glass fibres, mineral fibres, metallic fibres, carbon fibres, aramid fibres, potassium titanate fibres, sepiolite fibres and ceramic fibres. Metallic components for reinforcement may also have a shape other than a fibre shape. As is usual in the art, in the present application all metallic components included in the friction materials are considered as metallic reinforcing fibres whatever their shape is, such as fibre, chip, wool, etc. Examples of metallic fibres include steel, brass and copper, preferably steel. Since steel fibres often suffer from the drawback of rusting, zinc metal is often distributed over the friction material when steel fibres are used. Metallic fibres may be oxidised or phosphatised. An example of aramid fibres are Kevlar fibres. Ceramic fibres are typically made of metal oxides such as alumina or carbides such as silicon carbide. Reinforcing fibres are typically loose fibres, rather than fibre clusters.

The friction material formulation of the invention may comprise loose mineral fibres as reinforcing fibres, in addition to the MMVF clusters for the reduction of wear. The friction material formulation may include reinforcing fibres that comprise loose MMVF as part of a mixture of different types of fibres.

The friction material formulation may also include additives such as lubricants, abrasives, curing agents, crosslinkers, and solvents. Typical lubricants are graphite and metal sulphides such as antimony sulphide, tin sulphide, copper sulphide and lead sulphide. Abrasives typically have Mohs hardness values around 7-8. Typical abrasives are metal oxide abrasives and silicates abrasives, e.g. quartz, zirconium silicate, zirconium oxide, aluminium oxide and chromium oxide.

Other typical fillers may be organic or inorganic and include barium sulphate, calcium carbonate, mica, vermiculite, alkali metal titanates, molybdenum trioxide, cashew dust, rubber dust, sillimanite, mullite, magnesium oxide, silica, and iron oxide. The fillers may play a role in modifying certain characteristics of the friction material, e.g. enhancement of heat stability or noise reduction. Therefore the specific filler or fillers to be used depends on the other constituents of the friction material. Mica, vermiculite, cashew dust, and rubber dust are known as noise suppressors.

The friction material may have any suitable formulation. Preferred formulations include those referred to in the art as NAO/low-steel and NAO/non-steel. “NAO” refers to “non-asbestos organic”. NAO/low-steel and NAO/non-steel are particularly suitable for automotive applications such as brake pads and clutch linings. NAO/low-steel formulations typically include about 5 to 25 vol % of metallic components. NAO/non-steel formulations do not contain any steel.

A suitable formulation with which to make the friction material is:

| | Amount min | |
|---|---|---|
| Component | (% v/v) | Amount max (% v/v) |
| Novolac resin | 10 | 20 |
| Aramid fibre | 1 | 6 |
| Solid lubricants | 6 | 18 |
| Friction particles | 1 | 20 |
| Potassium titanate | 8 | 20 |
| Abrasives | 3 | 15 |
| Fillers | 10 | 25 |
| Promaxon ®-D (inorganic porous | 1 | 6 |
| particles) | | |
| MMVF clusters and optional | 8 | 18 |
| loose MMVF | | |
| Total | | |

In the finished friction product, the amount of MMVF clusters is preferably at least 1 wt %, such as at least 3 wt %, more preferably at least 5 wt %. The finished friction product preferably comprises less than 15 wt % MMVF clusters, such as less than 12 wt % MMVF clusters.

Suitable wear-reduction applications for friction materials according to the invention include automotive brake pads, clutch linings, industrial friction materials, railway blocks, railway pads, and friction papers. Preferably, the friction material of the invention is part of an automotive brake pad, more preferably in a NAO/non-steel or NAO/low-steel brake pad formulation for a passenger vehicle.

The friction material of the invention preferably has a density of from 2.0 to 3.0 g/cm³.

The friction material of the invention preferably has a porosity of from 10% to 25%, preferably from 15% to 25%.

The friction material of the invention preferably has a hardness (HRS) of from 50 to 100.

The friction material of the invention is particularly useful for reducing wear at elevated temperatures. Preferably the friction material is used to reduce wear at temperatures of at least 300° C., such as at least 500° C. Such temperatures may be found during periods of vehicle braking, in which the friction material of the invention is used as a brake pad for a passenger car.

### Example 1

Example 1 compares friction materials comprising fibre clusters having diameters all within the range 0.6 to 1 mm, according to aspects 2-5 of the invention, labelled in the data as Example 1A, with comparative friction materials comprising commercially available fibre spheres (Jiangsu REK High-Tec Materials Co., Ltd.) having a broad range of diameters, labelled in the data as Examples 1B and 10. A different product type of commercially available fibre spheres was used in each of Examples 1B and 10.

The quoted size distribution for the commercially available product is 8-16 mesh (1180-2360 μm), but measured values reveal a greater variation in size distribution (Table 2.1).

The fibre clusters made according to the invention were all within the range 0.6 to 1 mm, with clusters outside of this range removed by sieving.

Friction materials were prepared using a NAO/non-steel formulation (Table 1).

TABLE 1
NAO/non-steel formulation for wear tests of example 1.

| Component | Amount (% v/v) |
|---|---|
| Novolac resin | 16 |
| Aramid fibre | 3 |
| Solid lubricants | 12 |
| Friction particles | 10 |
| Potassium titanate | 17 |
| Abrasives | 11 |
| Fillers | 16 |
| Promaxon ®-D (inorganic porous particles) | 5 |
| Commercially available fibre spheres, or | 10 |
| fibre clusters according to the invention | |
| Total | 100 |

Friction material pads were prepared as follows. All components, except for the fibre spheres or fibre clusters, were combined in a high-speed MTI mixer in two mixing steps. The commercially available fibre spheres (Examples 1B and 1C) or the fibre clusters according to the invention (Example 1A) were combined with the remaining components in a third mixing steps. The resulting mixture was filled into moulds and hot pressed. Following the hot press, curing was carried out (2 hours, 200° C.).

The friction material pads were prepared as car brake pads for wear testing.

TABLE 2.1
measured size distribution of commercially available fibre spheres

| | Fibre ball distribution | | | | |
|---|---|---|---|---|---|
| | | >600 mu | >1000 mu | >1600 mu | |
| | <600 mu | <1000 mu | <1600 mu | <2360 mu | >2360 mu |
| | (%) | (%) | (%) | (%) | (%) |
| Example 1B | 3.2 | 1.5 | 14.0 | 71.5 | 9.0 |
| Example 1C | 7.5 | 17.0 | 26.5 | 39.5 | 9.5 |

TABLE 2.2
number average fibre diameter and length of fibre spheres and fibre
clusters used in the friction materials for Example 1

| | Number average | Number average | Aspect |
|---|---|---|---|
| | fibre length, μm | fibre diameter, μm | ratio L/D |
| 1A - fibre clusters | 118 | 4.66 | 25 |
| according to the | | | |
| invention | | | |
| 1B - commercially | 305 | 4.21 | 72 |
| available fibre | | | |
| spheres | | | |
| 1C - commercially | 244 | 3.70 | 66 |
| available fibre | | | |
| spheres | | | |

TABLE 2.3
measured properties of friction materials prepared for Example 1

| | | Example | Example 1B - | Example 1C - |
|---|---|---|---|---|
| | | 1A - fibre | commercially | commercially |
| | | clusters according | available fibre | available fibre |
| | | to the invention | spheres | spheres |
| Density | (g/cm³) | 2.17 | 2.19 | 2.21 |
| Porosity | (%) | 23.2 | 22.7 | 22.0 |
| Hardness | (HRS) | 63 stdev 5 | 55 stdev 6 | 69 stdev 12 |

TABLE 3
wear results from SAE J2521 testing

| | | | Example 1B - | Example 1C - |
|---|---|---|---|---|
| | | Example 1A - fibre | commercially | commercially |
| | | clusters according | available fibre | available fibre |
| | | to the invention | spheres | spheres |
| μ- | (μm) | 0.39 | 0.39 | 0.39 |
| mean | | | | |
| Pad | (g) | 2.5 | 2.8 | 3.4 |
| wear | | | | |
| Pad | (mm) | 0.25 | 0.28 | 0.33 |
| wear | | | | |
| Disc | (g) | 1.5 | 1.4 | 1.9 |
| wear | | | | |

As can be seen from Table 3, the brake pad that incorporated fibre clusters according to the invention exhibited lower wear in the SAE J2521 test setup compared to brake pads incorporating the same amount of commercially available fibre spheres having a broad distribution of sizes of fibre spheres.

TABLE 4
wear results from AKM (SAE J2522) test

| | | Example | | |
|---|---|---|---|---|
| | | 1A - | Example 1B - | Example 1C - |
| | | fibre clusters | commercially | commercially |
| | | according to | available fibre | available fibre |
| | | the invention | spheres | spheres |
| Disc wear | (g) | 3.0 | 3.0 | 2.9 |
| Overall mu | (mu) | 0.41 | 0.42 | 0.44 |
| (average) | | | | |
| μ 80 kph, 30 Bar, | (mu) | 0.41 | 0.43 | 0.44 |
| 100° (Av) | | | | |

### Example 2

Example 2 compares the wear properties of friction materials comprising fibres only in loose form, as is known in the art, with the wear properties of friction materials comprising fibre clusters according to the present invention.

The samples are labelled as follows:
Example 2A—loose fibres (short); the fibres making up the clusters have length 125±25 μm;
Example 2B—fibre clusters of size from 0.6 mm to 1.0 mm, made using the same fibres as 2A (short); the fibres making up the clusters have length 125±25 μm;
Example 2C—fibre clusters of size from 0.6 mm to 1.0 mm, made with medium length fibres; the fibres making up the clusters have length 300±50 μm;
Example 2D—fibre clusters of size from 0.6 mm to 1.0 mm, made with long fibres; the fibres making up the clusters have length 500±150 μm.

In Example 2, friction materials were made up according to a NAO non-steel formulation (Table 5) and either loose fibres or fibre clusters according to the invention.

TABLE 5
friction material composition for Example 2 wear tests

| Component | Amount (% v/v) |
|---|---|
| Novolac resin | 16 |
| Aramid fibre | 3 |
| Solid lubricants | 12 |
| Friction particles | 10 |
| Potassium titanate | 17 |
| Abrasives | 11 |
| Fillers | 16 |
| Promaxon ®-D (inorganic porous particles) | 5 |
| | 10 |
| Total | 100 |

The friction materials were prepared as follows. All components, except for the loose fibres or fibre clusters, were mixed in two stages (total time 4 minutes, 2000 rpm). The loose fibres or fibre clusters were incorporated into the mixture in a third mixing step (total time 1 minute, 500 rpm).

The resulting mixture was filled into moulds and pressed. Following pressing, a curing step was carried out (2 hours, 200°).

Three tests giving wear results were conducted in sequence using the same friction material pads: first test SAE J2521 Dynamometer, second test SAE J2522 Dynamometer, third test Krauss wear 150/300/500° C.

TABLE 6
wear results from SAE J2521 Dynamometer tests

| | | Example 2A | Example 2B | Example 2C | Example 2D |
|---|---|---|---|---|---|
| | | (loose | (fibre | (fibre | (fibre |
| | | fibres) | clusters) | clusters) | clusters) |
| μ-mean | (μ) | 0.42 | 0.40 | 0.39 | 0.38 |
| Pad | (g) | 4.21 | 2.89 | 3.38 | 2.72 |
| wear | | | | | |
| Pad | (mm) | 0.41 | 0.29 | 0.34 | 0.27 |
| wear | | | | | |
| Disc | (g) | 3.4 | 2.0 | 2.1 | 1.2 |
| wear | | | | | |

TABLE 7
wear results from SAE J2522 (AKM) Dynamometer tests

| | | Example 2A | Example 2B | Example 2C | Example 2D |
|---|---|---|---|---|---|
| | | (loose | (fibre | (fibre | (fibre |
| | | fibres) | clusters) | clusters) | clusters) |
| Pad wear | (g) | 8.48 | 8.94 | 8.26 | 8.26 |
| Disc wear | (g) | 3.3 | 3.4 | 2.4 | 2.5 |
| Overall | (μ) | 0.45 | 0.43 | 0.42 | 0.43 |
| mu | | | | | |
| (average) | | | | | |
| μ 80 kph, | (μ) | 0.45 | 0.43 | 0.42 | 0.43 |
| 30 Bar, | | | | | |
| 100° (Av) | | | | | |

TABLE 8
wear results from Krauss wear tests

| | | | Example | Example | Example |
|---|---|---|---|---|---|
| | | Example 2A | 2B | 2C | 2D |
| | | (loose | (fibre | (fibre | (fibre |
| | | fibres) | clusters) | clusters) | clusters) |
| Wear 150° C. | | | | | |
| μ | (μ) | 0.496 | 0.472 | 0.450 | 0.455 |
| Average | | | | | |
| Pad | (mg) | 12.1 | 13.1 | 12.9 | 13.5 |
| wear/brake | | | | | |
| Disc | (g) | 4.6 | 5.2 | 4.4 | 5.1 |
| wear | | | | | |
| Wear 300° C. | | | | | |
| μ | (μ) | 0.415 | 0.416 | 0.399 | 0.408 |
| Average | | | | | |
| Pad | (mg) | 22.3 | 21.8 | 25.3 | 23.0 |
| wear/brake | | | | | |
| Disc | (g) | 2.9 | 2.6 | 3.0 | 3.7 |
| wear | | | | | |
| Wear 500° C. | | | | | |
| μ | (μ) | 0.442 | 0.443 | 0.444 | 0.434 |
| Average | | | | | |
| Pad | (mg) | 67.1 | 61.0 | 57.9 | 68.1 |
| wear/brake | | | | | |
| Disc | (g) | 2.2 | 1.6 | 1.4 | 2.0 |
| wear | | | | | |
| Total wear | | | | | |
| Pad | (%) | 100 | 94 | 95 | 103 |
| wear/brake | | | | | |
| Disc | (%) | 100 | 86 | 84 | 109 |
| wear | | | | | |

These results show that using fibre clusters made from medium length fibres (Example 2C) resulted in the most stable coefficient of friction and using fibre clusters made from short or medium length fibres resulted in wear reduction compared to using loose fibres.

### Example 3

Example 3 compares the wear properties of friction materials comprising fibres only in loose form, as is known in the art, with the wear properties of friction materials comprising fibre clusters according to the present invention.

In Example 3, friction materials were made up according to a NAO low-steel formulation (Table 9) and either loose fibres or fibre clusters according to the invention.

Example 3A represents a friction material comprising loose MMVF, wherein the MMVF have fibre length 125±25 μm.

Example 3B represents a friction material comprising MMVF clusters all of size from 0.6 mm to 1.0 mm. The MMVF forming the clusters have fibre length 300±50 μm.

Example 3C represents a friction material comprising MMVF clusters all of size from 1.0 mm to 1.6 mm. The MMVF forming the clusters have fibre length 300±50 μm.

The size range of the MMVF clusters was controlled by sieving.

TABLE 9
friction material composition for Example 3 wear tests

| Component | Amount (% v/v) |
|---|---|
| Total | 100 |
| Cellulose | 7.0 |
| Barites | 8.0 |
| Steel Fibre | 3.0 |
| Friction particle | 6.0 |
| Resin | 18.0 |
| Petrol Coke | 22.0 |
| CPX 24 | 5.0 |
| Sponge Iron powder | 4.0 |
| Brass chips | 3.0 |
| Mica | 8.0 |
| Alumina Oxide | 1.0 |
| Black Iron Oxide | 5.0 |
| Loose fibres, or fibre clusters according to | 10.0 |
| the invention | |

The friction materials were prepared by mixing all of the ingredients, except for the loose fibres or fibre clusters, in two mixing steps in a mixer (total time 2 minutes, 2000 rpm). The loose fibres or fibre clusters were added in a third mixing step (1 minute, 1000 rpm). The resulting mixture was filled into moulds and pressed. Curing (2 hours, 200° C.) followed the pressing stage.

The same friction material pads were used in sequence for three tests: first test SAE J2521, second test SAE J2522, third test Krauss wear 150/300/500° C.

The wear measurements from each of the three tests are summarised in Table 10.

TABLE 10
wear results from SAE J2521 Dynamometer tests, SAE J2522 (AKM)
Dynamometer tests, and Krauss wear tests

| | | Example 3B | Example 3C |
|---|---|---|---|
| | Example 3A | (invention) | (invention |
| | (comparative) | Fibre clusters | Fibre clusters |
| | Loose fibres | 0.6-1.0 mm | 1.0-1.6 mm |
| Pad wear SAE | 7.9 | 7.9 | 8.3 |
| J2521 (NVH) (g) | | | |
| Pad wear SAE | 16.1 | 14.1 | 12.3 |
| J2522 (AKM) (g) | | | |
| Pad wear Krauss | 72.8 | 64.7 | 66.7 |
| tests (g) | | | |
| Total Pad wear (g) | 96.8 | 86.7 | 87.3 |
| Total Pad wear | 100 | 90 | 90 |
| (%) | | | |
| Disc wear SAE | 12.7 | 12.4 | 12.7 |
| J2521 (NVH) (g) | | | |
| Disc wear SAE | 2.9 | 2.7 | 3.0 |
| J2522 (AKM) (g) | | | |
| Disc wear Krauss | 6.9 | 9.1 | 9.4 |
| tests (g) | | | |
| Total Disc wear | 22.5 | 24.2 | 25.1 |
| (g) | | | |
| Total Disc wear | 100 | 108 | 112 |
| (%) | | | |

As can be seen, pad wear was lower for the examples 3B and 3C according to the invention, compared to the comparative example 3A that used only loose fibres and no fibre clusters.

1. Use of man-made vitreous fibre clusters as a component of a friction material formulation for the reduction of wear of said friction material.

2. Use according to claim 1, wherein the friction material is a brake pad.

3. Use according to claim 1, at a temperature of at least 300° C., preferably at least 500° C.

4. Use according to claim 1, wherein at least 95 wt % of the man-made vitreous fibre clusters have a largest dimension in the range of from 0.6 mm to 1.6 mm, preferably from 0.6 mm to 1.0 mm.

5. Use according to claim 1, wherein the man-made vitreous fibre clusters comprise no more than 2 wt %, preferably no more than 1 wt %, of shot of size >63 μm.

6. Use according to claim 1, wherein the man-made vitreous fibre clusters comprise a plurality of man-made vitreous fibres, the man-made vitreous fibres comprising less than 50 wt % SiO₂ and greater than 15 wt % Al₂O₃.

7. Use according to claim 1, wherein the man-made vitreous fibre clusters make up at least 1 wt %, preferably at least 3 wt %, more preferably at least 5 wt %, of the friction material.

8. Use according to claim 1, wherein the man-made vitreous fibre clusters make up no more than 15 wt %, preferably no more than 12 wt %, of the friction material.

9. Use according to claim 1, wherein the man-made vitreous fibre clusters comprise a plurality of man-made vitreous fibres, the man-made vitreous fibres having a number average aspect ratio of less than 40, preferably less than 30.

10. Mixture of man-made vitreous fibres comprising from 1 to 100% by weight man-made vitreous fibres in the form of clusters, wherein at least 95 wt % of said clusters have size in the range 0.6 mm to 1.6 mm.

11. Mixture according to claim 10 comprising at least 50 wt %, preferably at least 75 wt %, man-made vitreous fibres in the form of clusters and the balance of man-made vitreous fibres in the form of loose fibres.

12. Method for preparation of a friction material comprising the step of incorporating man-made vitreous fibre clusters into a friction material formulation, wherein the man-made vitreous fibre clusters have a size distribution such that at least 95 wt % have a size in the range from 0.6 mm to 1.6 mm.

13. Method according to claim 12, wherein the amount of fibre clusters is from 1 to 10 v/v % of the starting materials.

14. Method according to claim 12, wherein the man-made vitreous fibre clusters are incorporated as part of a mixture comprising from 1 to 100% by weight man-made vitreous fibres in the form of clusters, wherein at least 95 wt % of said clusters have size in the range 0.6 mm to 1.6 mm.

15. Friction material obtainable by the method of claim 12.
